(19) United States
(12) Patent Application Publication
(10) Pub. No.: US 2004/0135766 A1
(43) Pub. Date: Jul. 15, 2004

(54) Imaged toggled data input product

(76) Inventor: Leonard Reiffel, Chicago, IL (US)

Correspondence Address: DONALD F MOYER, 431 S DEARBORN 705, CHICAGO, IL, 60605

(21) Appl. No.: 10/344,459

(22) PCT Filed: Aug. 15, 2001
(86) PCT No.: PCT/US01/25478

(51) Int. Cl. G09G 5/00; G09G 5/08

(52) U.S. Cl. 345/156; 345/158

(57) ABSTRACT

An imager (12) having a field of view extending along three orthogonal axes detects positions (37) of a data appliance manipulated by a person in the field of view, detects the value of a toggle property (42, 72) of the data appliance manipulated by the person, and outputs a signal (13) which is equivalent to the position, left click, and right click signals from a computer mouse.

This application claims benefit of U.S. provisional application 60/226,183 filed 18 Aug. 2000.

The product comprises a data appliance manipulated by a person to a location in the field of view of an imager which detects light from the data appliance and outputs a signal to cause an information system to display a cursor at a display position functionally related to the location, which gives the product the cursor manipulating functions of a computer mouse. The data appliance has a toggle property which is manipulated by the person between two values to indicate an application choice and which is detected by the imager which outputs a toggle signal to cause the information to activate the application choice, which gives the product the click functions of a computer mouse. The product can also have a code property so that several data appliances can input distinguishable data to the information system. The product position relative to three orthogonal axes can be tracked.

The invention provides progress over prior art shown for example in U.S. Pat. No. 5,912,700 by Honey 15 Jun. 1999, U.S. Pat. No. 4,998,441 by Stuart 12 Mar. 1991, U.S. Pat. No. 4,099,050 by Sauermann 4 Jul. 1978, and U.S. Pat. No. 4,053,233 by Bein 11 Oct. 1977.

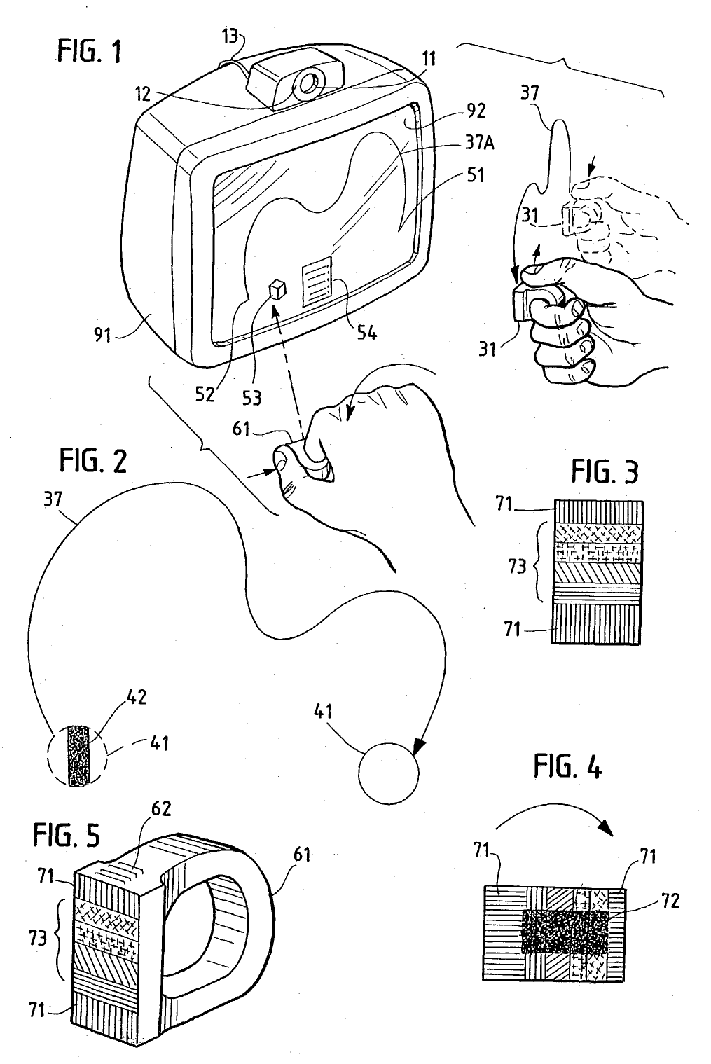

FIG. 1 depicts two data appliances in use.

FIG. 2 depicts light from a data appliance.

FIG. 3 depicts light from a data appliance.

FIG. 4 depicts light from the data appliance of FIG. 3 rotated.

FIG. 5 depicts a form of a data appliance.

The product comprises a data appliance 31, can comprise an additional data appliance 61, and comprises an imager 11 which detects light from the data appliance, and from any additional data appliance, and sends an output signal 13 to an information system 91 having a display 92.

The imager has a field of view which extends along three orthogonal axes. The data appliance is manipulated by a person to a location in the field of view—along path 37 for example. An additional data appliance can be manipulated by the person or by an additional person to an additional location in the field of view—to point to a displayed icon 53 for example.

Locate light 41 emanates from the data appliance. Preferably the locate light is from a source 12 adjacent to the imager and is retro-reflected by the data appliance. The locate light is detected by the imager. Additional locate light 71 can emanate from the additional data appliance. Preferably the additional locate light is from the source and is retro-reflected by the additional data appliance. Any additional locate light is detected by the imager.

The output signal from the imager has a locate component representing the location of the data appliance in the field of view. The locate component of the output signal causes the information system to display a cursor at a display position 52 functionally related to the location of the data appliance in the field of view. The display is perceived by the person. The person can use the display to move the data appliance to cause the cursor to be positioned where the person wants it positioned.

The output signal can have an additional locate component representing the additional location of the additional data appliance in the field of view. The additional locate component of the output signal causes the information system to display an additional cursor at an additional display position 53 functionally related to the additional location of the additional data appliance in the field of view.

The locate light has a toggle light property. The toggle light property has a toggle value which is manipulated by the person between a primary value—41 at the end of path 37 for example—and a secondary value—42 at the start of path 37 for example—to indicate an application choice—click-and-drag in the example—offered by the information system.

The toggle light property is detected by the imager. The output signal from the imager also has a toggle component representing the toggle value. The toggle component of the output signal causes the information system to activate the application choice—click-and-drag to trace the path 37A for example.

Any additional data appliance has an additional toggle light property of the additional locate light. The additional toggle light property has an additional toggle value which can be manipulated by the additional person between an additional primary value 73 and an additional secondary value 72 to indicate an additional application choice presented by the information system. The additional toggle light—property is detected by the imager.

The output signal then has an additional toggle component representing the additional toggle value. The additional toggle component of the output signal causes the information system to activate the additional application choice—invoking a menu 54 for example.

When there is an additional data appliance each data appliance can have a distinguishing code. Thus, the additional locate light can have an additional code light property which has an additional code value 73. The additional code value 73 is different from the code value—which can be just the code light 41 itself—of a code light property of the locate light

Any code light property and additional code light property are detected by the imager. The output signal then has a code component representing the code value and an additional code component representing the additional code value. The code component and the additional code component of the code signal cause the information system to distinguish the locate component and the toggle component corresponding to the data appliance from the additional locate component and the additional toggle component corresponding to the additional data appliance.

The several light properties here can comprise various physical properties of light in fixed, variable, and modulated modes. These physical properties of light comprise intensities, frequencies, phases, polarizations, entanglements, blink rates, decay times, external shapes, internal shapes, linear motions, rotational motions, strain motions, distances from at least one reference point, and combinations of two and more physical properties such as these. The several light property values here can be represented by patterns comprising these physical properties in fixed, variable, and modulated modes.

Light from data appliances can have various sources such as: light reflected from ambient sources; a data appliance light source; light emitted after energizing by suitable radiation; light emitted after energizing by suitable radiation with a characteristic decay time; a light source 12 adjacent to the imager illuminating the data appliance; and combinations of these.

Light is not limited to visible light. For example, infrared can be used, and millimeter and longer wavelengths can be used. Light can be radiating energy from any portion of the electromagnetic spectrum which can provide the functions required here. Other forms of radiating energy—such as acoustic energy—which can provide the functions required here are included in the meaning of “light” here.

The information system can act via any of various modes of processing. The processing can utilize configured processing elements such as hard wired circuits, can utilize configurable processing elements such as field programmable gate arrays and neural networks, can utilize instructions in a data-bearing medium, and can utilize combinations of these. The processing—in part at least—can be achieved at the imager.

The display can be any data output mode which can be perceived by a person—such as visual, audible, and tactile means. The display can be achieved by motions of a robot.

The primary value and the secondary value of the toggle light property are produced by a primary state and a secondary state of the data appliance. The secondary value can be achieved by the presence of a state such as the dark band depicted. The primary value can be achieved by the absence of the state such as the absence of the dark band.

The primary state and the secondary state can be achieved by any physical property of the data appliance. The dark band, for example, can be achieved by pressing a portion 62 of the data appliance with a thumb to actuate a physical property such as a mechanical shutter, a polarization, and a color change. Any means which can change any light property can be used to produce the two states of the data appliance and the two values of the toggle property.

A second toggle property can be provided by various means. The vertical dark band of FIG. 2 can represent a left click—and the horizontal dark band of the rotated data appliance of FIG. 4 can represent a right click—of a computer mouse. A toggle property which has more than two values can be provided by various means.

Code which identifies a data appliance is depicted as color bands. Any pattern of any light property which can be detected by the imager and can encode information can be used.

The data appliance is depicted as a ring worn on a finger. Any form which can be manipulated by a person can be used. For example, a data appliance can be held in a hand or in a mouth and can be attached to various parts of a person by various means.

The data appliance can be used as the equivalent of a computer mouse with both left click and right click functions achieved by the toggle property. For example, as depicted in FIG. 1, an appliance can—with the toggle held at the secondary value being equivalent to holding a left click (click-and-drag)—cause a line 37A to be drawn from 51 to 52 where the toggle reverts to the primary value. In another example, also as depicted in FIG. 1, an appliance can—with the appliance rotated ninety degrees and toggling to the secondary value of the toggle property being equivalent to a right click—right click on an icon to invoke a menu.

Several data appliances distinguished by different code properties—41 and 73 for example—can be used to input several sets of distinguishable data at the same time.

The position of the data appliance relative to all three orthogonal axes of the field of view can be determined by various means. For example, the imager can have components viewing the field of view from points separated in space so that the position of the data appliance relative to all three orthogonal axes of the field of view can be determined.

The imager can be the dual mode imager of patent application PCTUS/01/13742 filed 30 Apr. 2001. The coded data source depicted in FIG. 3 is a form which works well with the dual mode imager. The bands 71 retro reflect infra red light. The locate mode of the dual mode imager detects these bands. The react mode of the dual mode imager detects light from the region 73 over other light from the field of view. One of the bands is wider to define a direction. Other imagers and other forms of coded data sources can be used.

The imager—dual mode and otherwise—can have components separated in space. This can enlarge the field of view. This can facilitate determining the spatial positions of coded data sources. The imager can have several elements which selectively detect portions of a range of values of a physical property of light from a coded data source, with the several portions detected by the several imager elements being combined to detect the full range of the physical property of light without forming an image of the coded data source.

Claimed is:

1. An imaged data input product adapted to input data to an information system having a display, the product comprising:
an imager having a field of view,
the field of view extending along three orthogonal axes;
a data appliance,
the data appliance being manipulated by a person to a location in the field of view;
locate light emanating from the data appliance,
the locate light being detected by the imager;
an output signal from the imager,
the output signal having a locate component representing the location of the data appliance in the field of view,
the locate component of the output signal causing the information system to display a cursor at a display position functionally related to the location of the data appliance in the field of view,
the display position being perceived by the person;
a toggle light property of the locate light,
the toggle light property having a toggle value which is manipulated by the person between a primary value and a secondary value to indicate an application choice,
the toggle light property being detected by the imager,
the output signal having a toggle component representing the toggle value,
the toggle component of the output signal causing the information system to activate the application choice.

2. An imaged data input product adapted to input data to an information system having a display, the product comprising:
an imager having a field of view,
the field of view extending along three orthogonal axes;
a data appliance,
the data appliance being manipulated by a person to a location in the field of view;
locate light emanating from the data appliance,
the locate light being retro-reflected by the data appliance,
the locate light being detected by the imager;
an output signal from the imager,
the output signal having a locate component representing the location of the data appliance in the field of view,
the locate component of the output signal causing the information system to display a cursor at a display position functionally related to the location of the data appliance in the field of view,
the display position being perceived by the person;
a toggle light property of the locate light,
the toggle light property having a toggle value which is manipulated by the person between a primary value and a secondary value to indicate an application choice,
the toggle light property being detected by the imager,
the output signal having a toggle component representing the toggle value,
the toggle component of the output signal causing the information system to activate the application choice.

3. An imaged data input product adapted to input data to an information system having a display, the product comprising:
an imager having a field of view,
the field of view extending along three orthogonal axes;
a data appliance,
the data appliance being manipulated by a person to a location in the field of view;
an additional data appliance,
the additional data appliance being manipulated by an additional person to an additional location in the field of view;
locate light emanating from the data appliance,
the locate light being detected by the imager;
additional locate light emanating from the additional data appliance,
the additional locate light being detected by the imager;
an output signal from the imager,
the output signal having a locate component representing the location of the data appliance in the field of view,
the locate component of the output signal causing the information system to display a cursor at a display position functionally related to the location of the data appliance in the field of view,
the display position being perceived by the person,
the output signal having an additional locate component representing the additional location of the additional data appliance in the field of view,
the additional locate component of the output signal causing the information system to display an additional cursor at an additional display position functionally related to the additional location of the additional data appliance in the field of view,
the additional display position being perceived by the additional person;
a toggle light property of the locate light,
the toggle light property having a toggle value which is manipulated by the person between a primary value and a secondary value to indicate an application choice,
the toggle light property being detected by the imager,
the output signal having a toggle component representing the toggle value,
the toggle component of the output signal causing the information system to activate the application choice;
an additional toggle light property of the additional locate light,
the additional toggle light property having an additional toggle value which is manipulated by the additional person between an additional primary value and an additional secondary value to indicate an additional application choice,
the additional toggle light property being detected by the imager,
the output signal having an additional toggle component representing the additional toggle value,
the additional toggle component of the output signal causing the information system to activate the additional application choice;
a code light property of the locate light,
the code light property having a code value;
an additional code light property of the additional locate light,
the additional code light property having an additional code value,
the additional code value and the code value being different,
the code light property and the additional code light property being detected by the imager,
the output signal having a code component representing the code value and having an additional code component representing the additional code value,
the code component and the additional code component of the code signal causing the information system to distinguish that the locate component and the toggle component correspond to the data appliance and that the additional locate component and the additional toggle component correspond to the additional data appliance.

4. An imaged data input product adapted to input data to an information system having a display, the product comprising:
an imager having a field of view,
the field of view extending along three orthogonal axes;
a data appliance,
the data appliance being manipulated by a person to a location in the field of view;
a additional data appliance,
the additional data appliance being manipulated by an additional person to a additional location in the field of view;
locate light emanating from the data appliance,
the locate light being retro-reflected by the data appliance,
the locate light being detected by the imager;
additional locate light emanating from the additional data appliance,
the additional locate light being retro-reflected by the additional data appliance,
the additional locate light being detected by the imager;
an output signal from the imager,
the output signal having a locate component representing the location of the data appliance in the field of view,
the locate component of the output signal causing the information system to display a cursor at a display position functionally related to the location of the data appliance in the field of view,
the display position being perceived by the person,
the output signal having an additional locate component representing the additional location of the additional data appliance in the field of view,
the additional locate component of the output signal causing the information system to display an additional cursor at an additional display position functionally related to the additional location of the additional data appliance in the field of view,
the additional display position being perceived by the additional person;
a toggle light property of the locate light,
the toggle light property having a toggle value which is manipulated by the person between a primary value and a secondary value to indicate an application choice,
the toggle light property being detected by the imager,
the output signal having a toggle component representing the toggle value,
the toggle component of the output signal causing the information system to activate the application choice;
a additional toggle light property of the additional locate light,
the additional toggle light property having an additional toggle value which is manipulated by the additional person between an additional primary value and an additional secondary value to indicate an additional application choice,
the additional toggle light property being detected by the imager,
the output signal having an additional toggle component representing the additional toggle value,
the additional toggle component of the output signal causing the information system to activate the additional application choice;
a code light property of the locate light,
the code light property having a code value;
an additional code light property of the additional locate light,
the additional code light property having an additional code value,
the additional code value and the code value being different,
the code light property and the additional code light property being detected by the image,
the output signal having a code component representing the code value and an additional code component representing the additional code value,
the code component and the additional code component of the code signal causing the information system to distinguish that the locate component and the toggle component correspond to the data appliance and that the additional locate component and the additional toggle component correspond to the additional data appliance.
